(19) United States
(12) Patent Application Publication
(10) Pub. No.: US 2008/0244211 A1
(43) Pub. Date: Oct. 2, 2008

(54) MEMORY DEVICE AND CONTROLLER

(76) Inventor: Takafumi ITO, Ome-shi (JP)

Correspondence Address: OBLON, SPIVAK, MCCLELLAND MAIER & NEUSTADT, P.C., 1940 DUKE STREET, ALEXANDRIA, VA, 22314, US

(21) Appl. No.: 11/863,832

(22) Filed: Sep. 28, 2007

(30) Foreign Application Priority Data
Sep. 29, 2006 (JP) 2006-269335

(51) Int. Cl. G06F 12/02

(52) U.S. Cl. 711/170; 711/E12.003

(57) ABSTRACT

A memory device comprises a nonvolatile memory including memory areas that are defined in accordance with a security levels, and a controller configured to write to a first area that is part of the memory areas in an M-value mode and to a second area that is part of the memory areas and provides lower security level than the first area in an N-value mode (N>M).

### CROSS-REFERENCE TO RELATED APPLICATIONS

This application is based upon and claims the benefit of priority from prior Japanese Patent Application No. 2006-269335, filed Sep. 29, 2006, the entire contents of which are incorporated herein by reference.

### BACKGROUND OF THE INVENTION

1. Field of the Invention

The present invention relates to a memory device and a controller, and, for example, is applied to a memory card and a USB memory, and a controller controlling these memories.

2. Description of the Related Art

In recent years, some memory cards that are provided with a flash memory have security protection means. In the flash memory of the memory card, a plurality of memory areas are provided (see, for example, KOKAI Publication No. 2006-040264).

Information that is stored in memory areas with high security level of the memory areas is, for example, key information for accessing personal information and various kinds of confidential information and the like. Therefore, the memory area with high security level is required to have higher reliability than a general area that stores, for example, AV contents file and the like.

However, when writing to memory areas, a write mode was not selected in accordance with a security level. Therefore, reliability for a memory area with a high security level deteriorates.

### BRIEF SUMMARY OF THE INVENTION

According to one aspect of the present invention, there is provided a memory device comprising: a nonvolatile memory including memory areas that are defined in accordance with a security levels; and a controller configured to write to a first area that is part of the memory areas in an M-value mode and to a second area that is part of the memory areas and provides lower security level than the first area in an N-value mode (N>M).

According to one aspect of the present invention, there is provided a controller connectable to a nonvolatile memory that includes memory areas defined in accordance with a security level, controlling the nonvolatile memory, and writing to a first area that is part of the memory areas in an M-value mode and to a second area that is part of the memory areas and provides lower security level than the first area in an N-value mode (N>M).

### BRIEF DESCRIPTION OF THE SEVERAL VIEWS OF THE DRAWING

FIG. 1 is a plan view showing a memory device according to a first embodiment of the present invention;

FIG. 2 is a plan view showing an internal configuration of the memory in the FIG. 1;

FIG. 3 is a diagram for illustrating write modes;

FIG. 4 is a diagram showing how the memory in FIG. 1 is partitioned in accordance with different formats;

FIG. 5 is a diagram showing a relationship among memory areas, write modes, and file systems;

FIG. 6 is a diagram showing a typical file structure;

FIG. 7 is a diagram showing a file configuration implemented using ICB;

FIG. 8 is a diagram schematically showing a file structure recognized by a DVD-R file system when the file system is applied to a memory card;

FIG. 9 is a diagram showing the example of VAT;

FIG. 10 is a diagram showing the example of the configuration of each page; and

FIG. 11 is a diagram showing a memory device according to a second embodiment of the present invention;

### DETAILED DESCRIPTION OF THE INVENTION

Embodiments of the present invention will be described below with reference to drawings. Note that common feature is denoted by the same reference numeral through all drawings in the description.

### First Embodiment

### One Example of a Memory Card

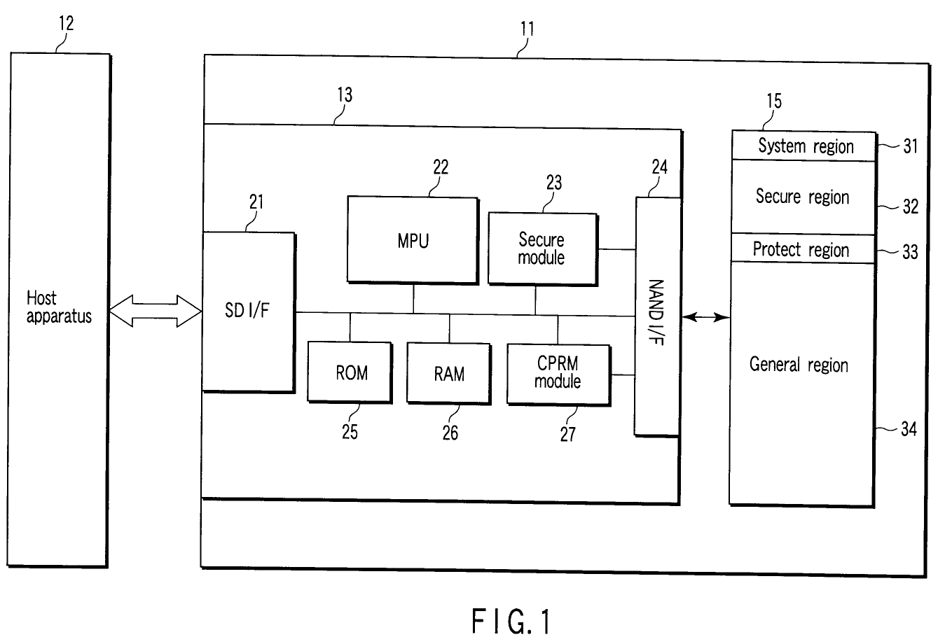

First, description will be given of a memory device according to a first embodiment of the present invention with reference to FIG. 1. FIG. 1 is a block diagram showing the memory device according to the embodiment. In the example, description will be given of a memory card as an example of the memory device.

As shown, a memory card (memory device) 11 includes a controller 13 and a memory 15, and performs data transfers and the like with a host apparatus 12. The host apparatus 12 is, for example, a cellular phone or a personal computer and the like. In the example, description will be given of a multi-level NAND type flash memory as an example.

The controller 13 is configured to manage the internal physical state of the flash memory 15 (which logical address data is contained in a certain physical block address and what block is in an erased state) via an NAND I/F 24. Further, the controller 13 performs data input and output control on the memory 15, data management, addition of error correction codes (ECC) on data write, and analysis and process of the error correction codes (ECC) also on reading. Moreover, the controller 13 is configured to write data in a predetermined write mode to each of memory areas that are partitioned in the memory 15 as described below.

The controller 13 includes an SD I/F 21 as a host interface, a micro processing unit (MPU) 22, a secure module 23, the NAND I/F 24 as a memory interface, a read-only memory (ROM) 25, a random access memory (RAM) 26, and a content protection for recordable media (CPRM) module 27.

The SD I/F 21 is provided to perform data transfers and the like between the controller 13 and the host apparatus 12, and is a host interface compliant with the interface of SD™ memory card.

The MPU 22 is configured to control whole operation of the memory 15. Further, the MPU 22 receives write commands, read commands, and erase commands from the host apparatus 12, performs predetermined operations on the memory 15, and manages data transfer processes via the RAM 26.

The secure module 23 writes and reads data to and from a secure region 32 in the memory 15 only after the host apparatus 12 is validated through mutual authentication between the memory card 11 and the host apparatus 12. Further, the secure module 23 performs advanced encryption process for security when reading data from the secure region 32. Therefore, transfer of data in the secure region 32 between the memory card 11 and the host apparatus 12 is performed with the data in the encrypted state.

The NAND I/F 24 is a memory interface that is provided to transfer data and the like between the controller 13 and the memory 15.

The RAM 26 is configured to temporarily store a predetermined amount (for example, one page) of data and commands and the like during, for example, writing of data sent from the host apparatus 12 to the memory 15.

The ROM 25 is configured to store firmware (control program) for controlling the MPU 22. When, for example, the memory card 11 is powered on, the MPU 22 loads the firmware onto RAM 26 to execute predetermined process to create various kinds of tables onto the RAM 26.

The CPRM module 27 is configured to perform encryption process, which adds codes for copy right protection, and authentication process on writing of data to a protect region 33 in the memory 15, and decoding codes and authentication process on data reading.

The memory 15 is a NAND type flash memory that includes a plurality of memory areas that are partitioned in accordance with a security level. In the present example, the memory 15 includes a system region 31, a secure region 32, a protect region 33, and an general region 34 as memory areas to which data can be written.

The system region 31 stores data that is important for security reason, and is accessible only after the host apparatus 12 is validated through mutual authentication between the memory card 11 and the host apparatus 12 that is coupled to the memory card 11.

The secure region 32 is accessible by the host apparatus 12 only after the host apparatus 12 is validated through mutual authentication between the memory card 11 and the host apparatus 12.

The memory 15 also includes a management area (not shown) that stores security information and media ID and the like.

The protect region 33 is a region that stores data related to a copy right protection, stores a key information used for encryption and confidential data used for authentication, and is not accessible by the host apparatus 12.

The general region 34 is freely accessible and can be freely used by a user of the memory card 11, and stores, for example, user data, such as AV contents files and image data.

Signals that are transferred between the controller 13 and the memory 15 are as follows.

A chip enable signal is used to select the mode of the memory 15, and is sent from the controller 13 or the host apparatus 12. When, for example, the CE is “H level”, the memory 15 is in a standby mode that disables reading and writing. When the CE is made “L level”, then the memory 15 goes into an operation mode that enables reading and writing.

A READY/BUSY signal (R/B) is used to inform an outside of the memory 15 of an internal operation state of the memory 15. The memory 15 sends R/B indicative of “busy state” while memory 15 is in operation. On the other hand, the memory 15 sends R/B indicative of “ready state” when operation of the memory 15 is finished.

Control signals such as an address latch enable signal (ALE) and a command latch enable signal (CLE) are used to identify signals sent to the memory 15 as address, command, or data.

I/O signal is command, address, or data signal, and is transferred on an I/O bus.

### <Internal Configuration of NAND Type Flash Memory 15>

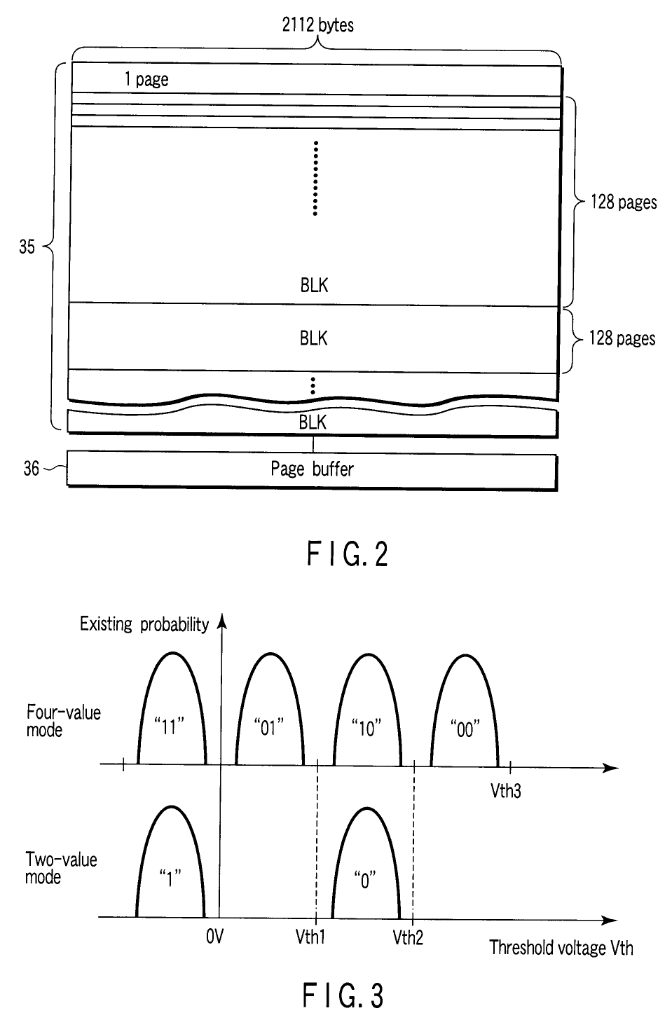

Next, referring to FIG. 2, description will be briefly given of the internal configuration of the NAND type flash memory 15. FIG. 2 is a block diagram showing the NAND type flash memory 15.

As shown, the memory 15 includes a memory cell array 35 and a page buffer 36.

The memory cell array 35 includes a plurality of memory blocks BLK0 to BLKn (n being natural number equal to or more than 1). Each memory block BLK includes a plurality of memory cell transistors. A description will be given of an example of the memory cell array 35 of the present example that is a multi-value NAND type flash memory that can store multi-bit data in a memory cell transistor. Note that the memory blocks BLK0 to BLKn may be simply referred to as blocks BLK in the following description.

Here, a write mode in which multi-bit data is written in a memory cell transistor is referred to as a multi-value mode, and a write mode in which one-bit data is written in a memory cell transistor is referred to as a two-value mode. In this case, a memory cell transistor in which data has been written in the two-value mode can be rewritten in the multi-value mode.

Further, data erasure is performed in units of the memory blocks BLK. That is, data in the same memory block BLK is collectively erased. Each memory block BLK includes a plurality of memory cell transistors. Further, in each memory block BLK, word lines WL0, WL1, . . . (hereinafter, referred to as word lines WL) and bit lines BL0, BL1, . . . (hereinafter referred to as bit lines BL) that are perpendicular to the word lines WL. And, memory cell transistors in the same row are connected to the same word line. Further, memory cell transistors in the same column are connected to the same one bit line BL. Writing and reading of data are performed to each set of memory cell transistors, which is referred to as a page. In reading or writing, a row address is used to select one of the word lines WL, a column address is used to select one of the bit lines BL.

In the example of FIG. 2, each page of the memory 15 has 2112 bytes (512-byte data storage area×4+10-byte redundancy area×4+24-byte management-data storage area), and each memory block BLK includes, for example, 128 pages.

The page buffer 36 inputs and outputs data from and to the memory 15, and temporarily holds data. A size by which the page buffer 36 can hold data is equal to the page size of each memory block BLK and is 2112 bytes (2048 bytes+64 bytes). In data write and the like, the page buffer 36 performs process of data input and output from and to the memory 15 in units of pages each of which corresponds to its own memory capacity.

### <Write Mode>

Next, referring to FIG. 3, description will be given of the two-value mode and the multi-value mode. Four value mode will be explained as an example of the multi-value mode. In FIG. 3, the abscissa axis represents a threshold voltage Vth, and the ordinate axis represents existing probability of a memory cell.

First, description will be given of the four value mode. As shown, a memory cell transistor can hold four kinds of data, that is, “11”, “01”, “10”, and “00” in order of increasing threshold voltage. A memory cell transistor that holds “11” data has a threshold voltage Vth of Vth<0V. A memory cell transistor that holds “01” data has a threshold voltage Vth of 0V<Vth<Vth1. A memory cell transistor that holds “10” data has a threshold voltage Vth of Vth1<Vth<Vth2. A memory cell transistor that holds “00” data has a threshold voltage Vth of Vth2<Vth<Vth3.

Next, description will be given of the two-value mode. As shown, a memory cell transistor can hold two kinds of data, that is, “1” and “0” that have the lower and higher threshold voltage, respectively. A memory cell transistor that holds “1” data has a threshold voltage Vth of Vth<0V. A memory cell transistor that holds “0” data has a threshold voltage Vth of Vth1<Vth<Vth2. In other words, “1” data in the four value mode has the same threshold voltage as that of “11” data, and the “0” data has the same threshold voltage as that of “10” data.

In other words, it can be said that the two-value mode is a mode that uses only the lower bit of two bits in the four value mode. The controller 13 controls whether data is written to memory cell transistors in the two-value mode or in the four value mode. More specifically, a lower page address is assigned to the lower bit of two-bit data, and an upper page address is assigned to the higher bit thereof. When data is written to cell transistors in the two-value mode, the controller 13 uses only lower page addresses of page addresses to write data to the memory 15. When data is written to cell transistors in the multi-value mode the controller 13 uses both the higher page addresses and the lower page addresses to write data to the memory 15.

First, data write is performed on lower bits. Assume that erased state is “11” (“- -” and - being undefined). First, writing is performed on lower bits, and then a memory cell transistor MT holds “11” (“−1”) or “10” (“−0”). The writing finishes here in the two-value mode. Then, writing is performed on upper bits in the four value mode. As a result, a memory cell transistor MT that has held “11” (“−1”) becomes to hold “11” or “01”, and a memory cell transistor that has held “10” (“−0”) becomes to hold “10” or “00”. The same holds true for other mode, such as eight-value mode or sixteen-value mode.

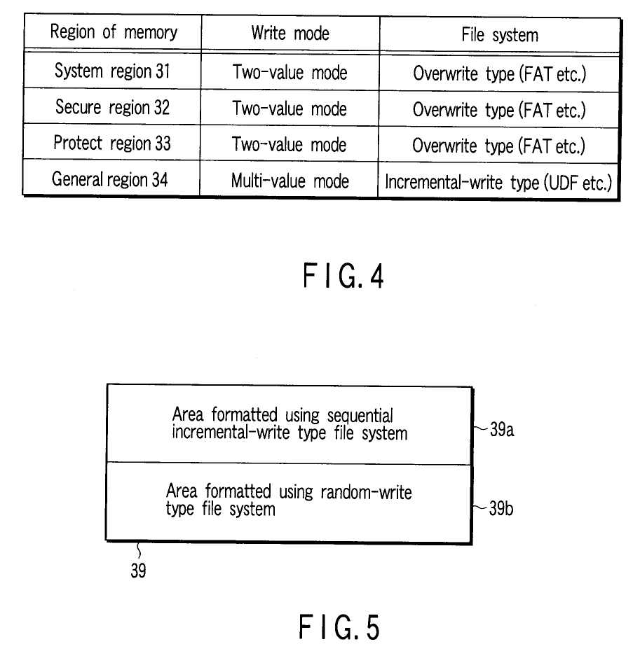

Next, referring to FIG. 4, description will be given of a relationship among the storage areas, write modes, and file systems. As shown, in the present example, a write mode for the system region 31, the secure region 32, and the protect region 32, which require higher security level, is two-value mode. In this instance, the controller 13 controls the memory 15 to perform writing to the system region 31, secure region 32, and protect region 33 in the second value mode.

On the other hand, a write mode for the general region 34 is multi-value mode (the four-value mode in the present example). In this instance, the controller 13 controls the memory 15 to perform writing on the general region 34 in the multi-value mode.

Further, a file system for the system region 31, the secure region 32, and the protect region 33 is a overwrite type file system (for example, FAT, described later), which writes data in an order irrelevant to address increment direction. In this instance, host apparatus 12 controls memory 15 to write data in accordance with the overwrite type file system.

On the other hand, a file system for the general region 34 is an incremental-write type file system (for example, UDF, described later). In this instance, host apparatus 12 controls the memory 15 to write data in accordance with the incremental-write type file system.

That is, using description of (memory region, write mode, file system), the aforementioned relationship is described as (system region 31, two-value mode, overwrite type (FAT)), (secure region 32, two-value mode, overwrite type (FAT)), (protect region 33, two-value mode, overwrite type (FAT)), (general region 34, multi-value mode, incremental-write type (UDF)).

### <File System>

Next, description will be given of file systems. In general, an NAND type flash memory of a memory card is formatted using a FAT file system. In this embodiment, as shown in FIG. 5, a region 39a (general region 34), which is at least part of memory 15, is formatted using a sequential-access incremental-write type file system. The remaining region 39b (the secure region 32 and protect region 33) is formatted using a random-write type file system.

First, description will be given of an incremental-write type file system. With the incremental-write type file system, data is sequentially written in sectors starting from lower sector (write area) address and going to a higher sector address. In the description below, the phrase “the file system writes and reads data” and descriptions meaning this shall mean that the file system instructs the controller 13 to write and read data and that the controller 13 actually writes and reads data to and from the flash memory 15.

The adoption of the incremental-write type file system for the memory card 11 eliminates the need for frequent data erasure and rewrite operations. As a result, efficient file write and rewrite operations are expected for some applications.

Further, the application of the incremental-write type file system to the memory card 1 eliminates the need for block erasures during a file write operation. This prevents a decrease in file write speed. Furthermore, since sequential write operations are performed, extra processing such as a move-accompanying write operation is not required. This is expected to increase the speed of a write process.

The sequential-access incremental-write type file system includes, for example, a universal disk format (UDF). UDF is a file system employed in DVD. With UDF, the positions (sector addresses) of file entries are described in an allocation table called information control block (ICB). ICB is provided for each file. ICB of the file is rewritten for each file update.

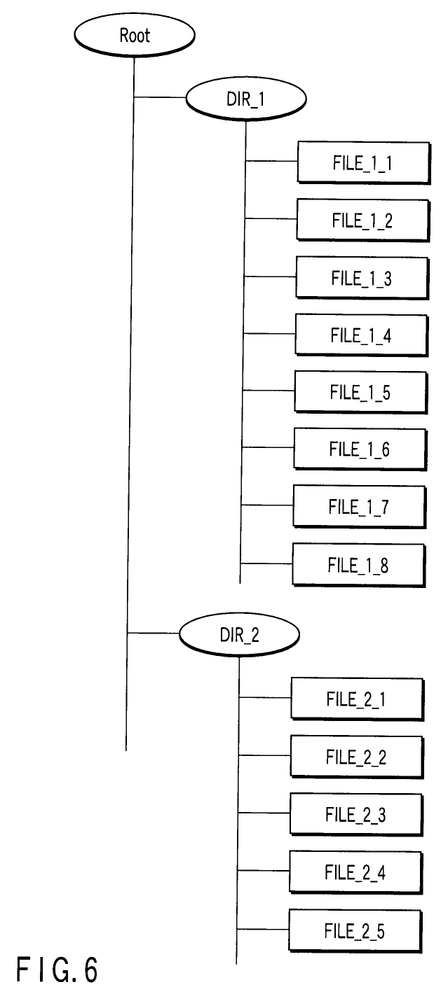

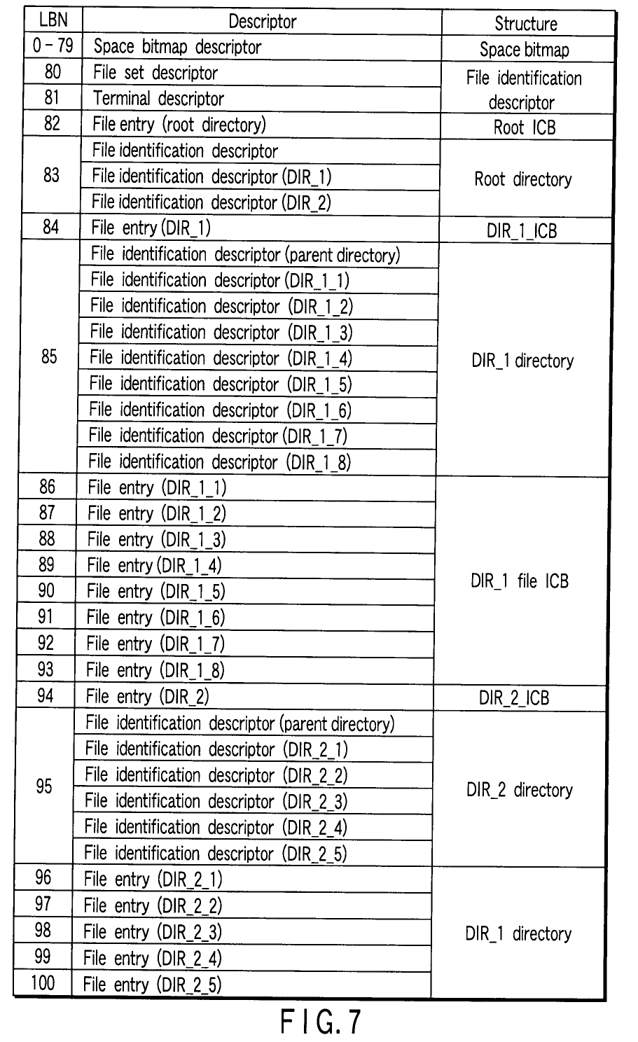

The structure of ICB will be described with reference to FIG. 6. Such a configuration as shown in FIG. 6 corresponds to the file structure shown in FIG. 7 and using ICB. When a file is accessed, the address is accessed at which ICB of the file is described. The name of the file and the address of the file entry are described using file identification descriptors in ICB. The file entry includes the position of the file entity and the file size and file attribute. Actual data of the target file is stored at the address of the file entity described in the file entry.

A similar structure is also formed when a subdirectory is provided. ICB (LBA82) of a root directory describes the address (LBA83) of a file entry of the root directory. Directory information on the root directory is described in an area specified by this addresses. The directory information includes the addresses (LBA84 and 94) of ICBs of subdirectories.

ICB of the subdirectory describes the address of ICB of each of the files of the subdirectory. As described above, the file entry of the file is described at the address described in ICB of the file. The actual (real) address is identified with reference to the file entry.

### [2-1] File System Types

Standards for writable DVDs include DVD-R, DVD-RW, and DVD-RAM. The file system varies depending on the characteristics of disks. Each file system will be described below. Any of these file systems can perform sequential-access incremental-write operations. Description will be given below of file systems that can be adopted in the present embodiment.

### [2-1-1] DVD-R Type File System

With the DVD-R type file system, written data cannot be erased or rewritten. In a write operation, data are sequentially written starting from a lower sector address. Therefore, the DVD-R type file system updates, erases, or adds files on the basis of incremental write operation, using VAT, described later. The DVD-R type file system, which is of a incremental-write type, has a conversion table called virtual allocation table (VAT), as a file.

VAT describes the correspondences between virtual sector addresses and logical sector addresses. To access a certain address, the host apparatus 12 uses VAT to convert a virtual sector address into a logical sector address and then access the logical sector thus obtained.

Then, during an incremental write operation, data is additionally written to a file entity, and the logical sector address in VAT is changed which corresponds to the virtual sector address of ICB of this file. Consequently, the logical sector address to be actually accessed is changed. This allows the file to be updated without the need to rewrite written sector data.

VAT is referenced when the actual (latest) address is determined from the virtual address of a file entry described using a file identification descriptor. In other words, the pointer (address) of the file entity (directory entity) described in the file entry is the real address, which need not be converted using VAT.

Further, the update of VAT itself is carried out by always writing ICB of VAT itself (VAT ICB) in the final one of written areas in a medium.

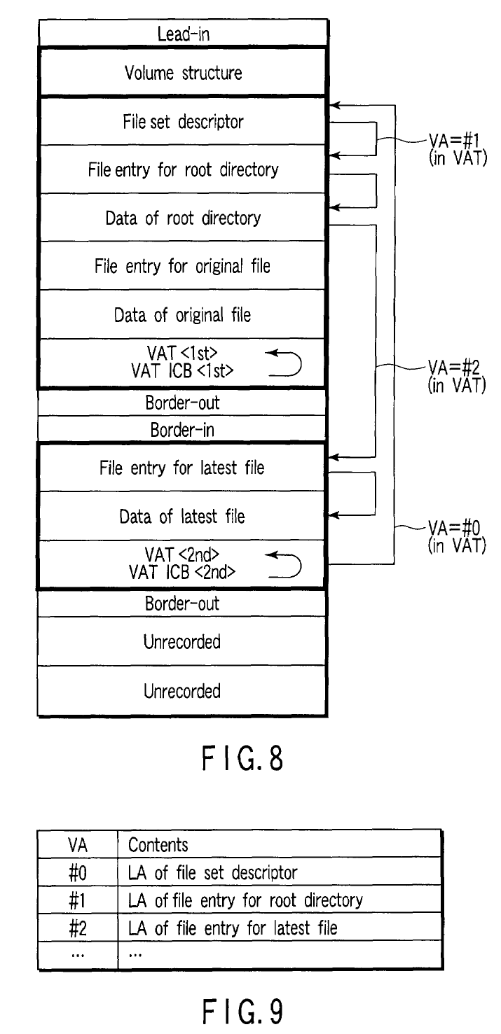

FIG. 8 is a diagram schematically showing a file structure recognized by the DVD-R file system applied to the memory card 11. FIG. 8 shows that the file has been subjected to one update, delete, or add operation.

As shown in FIG. 8, the file configuration has a volume structure, a file set descriptor, a file entry for the root directory, and data of the root directory arranged in this order from the top to bottom of the file. These are followed by a file entry for the file described during the first write operation (original file), that is, the file before the addition, deletion. Original file data succeeds the file entry. Original file data is followed by VAT produced during the first write operation (VAT<1st>) and ICB of this VAT.

Following a border-in and -out areas following VAT<1st> and ICB, a file entry for the updated file and the updated file are located. The file entry and the updated file are followed by VAT produced during the update operation (VAT<2nd>) and ICB of this VAT. Following a border-out area following VAT<2nd> and ICB, a series of unwritten areas are present. FIG. 9 shows an example of VAT<2nd>. As shown in FIG. 9, virtual addresses are associated with logical addresses.

To read data from a file, the file system reads the latest VAT ICB. VAT ICB is always located at the tail end of the written areas. In the example shown in FIG. 8, VAT ICB<2nd> is accessed.

With reference to the position of the latest VAT described in VAT ICB<2nd>, the file system reads VAT. Then, the file system accesses the file set descriptor. On this occasion, the logical address of the file set descriptor is determined from a virtual address #0 using VAT.

Then, the file system reads the file entry for the root directory from the address described in the file set descriptor. Actually, the file system reads ICB and then accesses the address of the file entry described in ICB.

Then, the file system uses VAT and a virtual address #1 described in the file entry for the root directory to access the data of the root directory. Then, the file system accesses ICB of the latest file at the virtual address described in the data of the root directory. The file system then uses VAT and a virtual address #2 described in this ICB to access the file entry for the latest file. Then, the file system reads the data of the latest file from the address described in the file entry.

If the DVD-R type file system is adopted for the flash memory, it may be difficult to distinguish written areas from unwritten areas in the ordinal memory read.

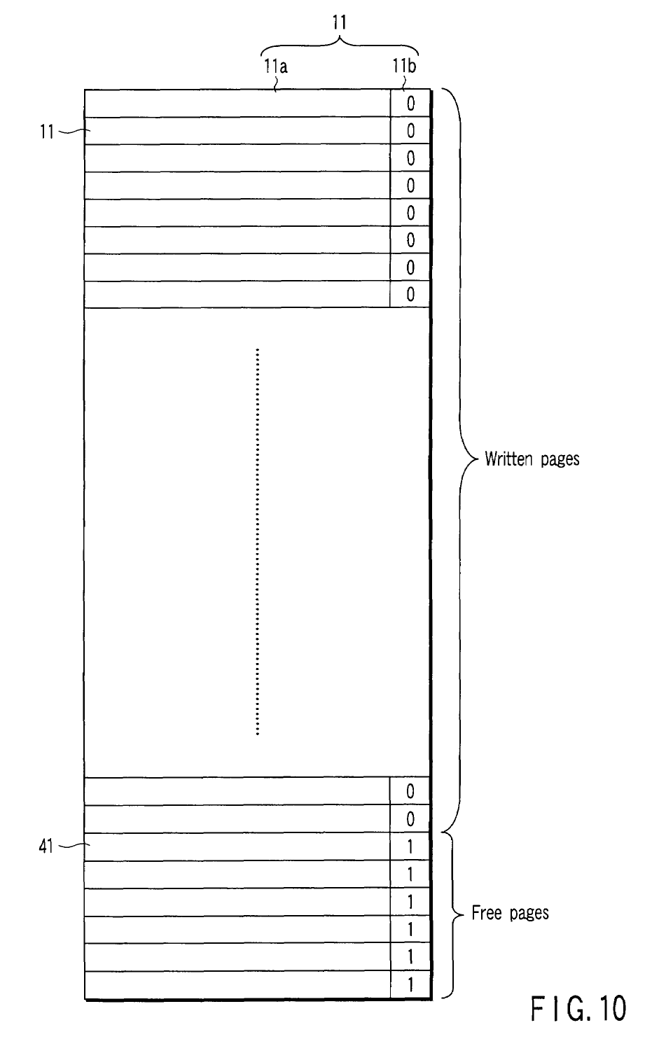

Therefore, if the flash memory 15 is formatted using the DVD-R type file system, each page 41 is composed of a data storage section 41a and a redundant section 41b as shown in FIG. 10. Then, the redundant section 41b of each page is used as a written state information section provided with a flag indicating a written state or a free state. Checking this flag makes it possible to determine the highest page to be the “final written area”.

Since the flag information is present in the redundant section 41b, the host apparatus 12 cannot use a conventional memory read command for the memory card 11 to read the flag information. Therefore, the SD I/f 21 is provided with a command used to load information on written areas based on the flag information.

During write operation, the controller 13 additionally writes flags in pages along with data. However, this method can be used only for a sequential write system such as the DVD-R system. Further, to determine the final written area, the controller 13 must retrieve the pages.

The following technique may be used to efficiently retrieve the final written area. The controller 13 checks the flags while dividing a retrieval target in the memory area of the flash memory into two one after another. That is, first, a check is performed on the flag of the redundant section of the page immediately after the boundary obtained by the first division. If this flag indicates a free state, the former half obtained by the first division is determined to be a retrieval target. Similarly, if the flag indicates a written state, the latter half obtained by the first division is determined to be a retrieval target.

Then, the new retrieval target (the first half or the second half of the divided target) is divided (second division). A check is performed on the flag of the redundant section of the page immediately after the boundary obtained by this division. The above operation is repeated to enable the final written area to be efficiently detected.

Further, to recognize the final written area, it is possible to, for example, provide the secure region 32 with a dedicated area in which the final written area is stored. In this case, the controller 13 need not retrieve each page in order to determine the final written area. However, block erasure must be carried out at a particular time while a write operation is being performed on the dedicated area.

As described above, since with the DVD-R type file system, VAT ICB is written in the final part of the written areas, the final written area must be detected for an operation. By providing the flag indicating the written or free state as in the case of the present embodiment, it is possible for the controller 13 to detect the final written area in a short time.

With the DVD-R type file system, already written data cannot be erased or rewritten and data is sequentially written starting from a lower sector address as described above. Owing to this characteristic, the application of the DVD-R type file system to the flash memory precludes block erasure from occurring during a file update, additional write or delete operation. For writing, only sequential-access incremental-write operations are possible.

### [2-1-2] DVD-RW File System

The DVD-RW type file system realizes update, additional write, and delete of files by rewriting sector data (ICB and the like).

When an unwritten area is available, the file can be updated by rewriting ICB and additionally writing data to the file entity. When no unwritten area is available, written area need to be rewritten or an unwritten area must be provided by using the file system to reconfigure the files in the memory card (garbage collection).

The DVD-RW type file system is provided with a sparing area used to compensate for a bad sector resulting from repeated rewrite operations because only a small number of rewrite operations can be performed on DVD-RW. If a bad sector occurs, the sparing table is used to change an access to the bad sector to one to the sparing sector. The DVD-RW type file system supports such a conversion mechanism. The DVD-RW type file system carries out sparing in unit of packets.

On the other hand, the controller 13 normally manages bad sectors in the memory card 11. If the DVD-RW type file system manages the files in the flash memory 15, the controller 13 does not need to manage bad sectors any more. This makes it possible to reduce a burden on the controller 13.

[2-1-3] DVD-RAM Type File System

Like DVD-RW, a DVD-RAM type file system realizes update, additional write, and delete of files by rewriting sector data (ICB and the like). The DVD-RAM type file system executes other processes in almost the same manner as that in which DVD-RW performs the processes. However, a large number of, specifically, about 100,000 rewrite operations can be performed on DVD-RAM. Consequently, this file system does not support the means for providing spares for bad sectors using the sparing area and sparing table.

### [2-2] Setting of File System

Now, description will be given of criteria used to set (select) an appropriate file system.

### [2-2-1] Setting of File System Based on Capacity

The memory card can be efficiently used by setting the appropriate file system depending on applications or conditions. The appropriate file system will be described below.

If the memory card 11 has a large capacity, it is preferable to adopt a file system such as UDF, which can deal with sequential write media. As described above, UDF has three types of file systems. Any of the file systems is preferably adopted depending on the capacity of the memory card 11.

For a large capacity, a file system such as the DVD-R system is preferably adopted, which can deal with sequential write media.

For a large but relatively small capacity, it is preferable to employ a file system such as the DVD-RW system or DVD-RAM system, which is based on rewritable media.

If the memory card 11 has a small capacity, the current FAT file system is preferably used. With a incremental-write type file system such as UDF, repeated file updates increase unavailable written areas. Garbage collection is required to reduce the unavailable areas to provide free areas. A smaller capacity requires garbage collection to be frequently carried out. This may impair the convenience of the memory card. Further, UDF has a larger management information area than FAT and is also unsuitable for small-capacity memory cards in this regard.

### [2-2-2] Setting of File System Based on Applications

It is preferable to employ a file system such as a FAT file system, which is based on random rewritable media, for applications involving a small file size or frequent file rewrite operations (typical office data file applications such as mails and documents).

A file system such as UDF, which can deal with sequential write media is preferably adopted for applications involving a large file size and infrequent updates of the same file (multimedia such as images, music, or videos)

### [2-3-1] Case of FAT

For the FAT file system, a memory control type is used, which is used for the FAT file system. That is, the memory card 11 executes a move accompanying write operation, which is described later.

### <Move Accompanying Write>

If a write (update) operation is attempted on a written page in the flash memory 15, a move accompanying write process is executed as described below. Since flash memory 15 executes erasure in units of blocks, the following process are required.

1) One erased block (B) is prepared.

2) The data in all the written pages in a block (A), which contains a rewrite target page, except the rewrite target page is copied to a block (B).

3) The data of the rewrite target page is written to the block (B).

4) The logical address of the block (A) is replaced with that of the block (B).

### [2-3-2] Case of UDF (DVD-R File Systems)

With the DVD-R type file system, update, additional write, and delete of files trigger no block erasure, and write operations are performed on an additional, sequential basis. Therefore, the memory card 11 does not perform the move accompanying write operation or any special processes such as the one executed for the FAT file system. The memory card 11 does not provide any memory area required for the special process.

### [2-3-3] Identification of File System by Controller

The controller 13 must identify the file system in order to change the memory control type depending on the file system. An embodiment of an identification method will be shown below.

The file system is identified on the basis of format information (for example, file system information in the partition table). This identification method does not require that the host 20 perform any special operations but requires that the controller 13 can recognize the format information to determine the format type.

A format information setting area is provided in the flash memory 15, and the host 12 sets identification information. This identification method does not require the memory card 11 to recognize format data.

[3] Addition of UDF Specification and Definition of Parameters in Accordance with Characteristics of Flash Memory

Logical format parameters for the file system preferably include not only the sector size and the packet size, which is a write unit, but also the block (erasure unit) BLK size of the flash memory 15. This enables the file system to manage files in accordance with the erasure characteristic of the flash memory 15. When the file system knows the block size of the flash memory 15, the following process is possible.

First, when the DVD-RW type file system is adopted, the file system preferably manages the sparing table and sparing area in units of the block sizes written in the logical format parameters. That is, in view of efficiency, the size of a managed unit for the sparing table and sparing area is preferably the same as that of each block in the flash memory 15. This eliminates the need to provide sparing blocks in the memory card, thereby preventing an initial decrease in user area.

Further, preferably, the utility and file system of the host apparatus 12 preferentially carry out the garbage collection and deflagging in units of blocks.

In the garbage collection and deflagging, where data is frequently moved from a written block to another block, carrying out this in units of blocks enables the process to be executed efficiently. Further, in this case, the use of the “memory area moving command” enables the process to be executed more efficiently.

Further, preferably, the file system of the host apparatus 12 preferentially describes all ICBs of the file in one block. This makes it possible to minimize the number of blocks rewritten when each ICB is rewritten in connection with the garbage collection. This improves the data movement and ICB rewrite operations to be more efficiently performed during the garbage collection or deflagging.

According to the embodiment, advantages, for example, described in following item (1) and (2) can be obtained.

(1) Write operation in accordance with a security level is possible, thereby improving reliability.

As shown in FIG. 4, write mode for the system region 31, the secure region 32, and the protect region 33, which require higher security level, is two-value mode. In this instance, the controller 13 controls the memory 15 to perform writing in the system region 31 in the two-value mode.

Here, the system region 31, the secure region 32, and the protect region 33 hold information, which requires higher security level than that stored in the general region 34, such as key information. Therefore, those regions need to provide higher durability for data, but does not need to have large data capacity.

For this reason, by writing to these regions in the two-value mode, which provides lower durability, the security protection and the reliability can be improved.

On the hand, the general region 34 holds information, for example, video data, which dose not require data durability, but demands large capacity. Therefore, by writing to the general region 34 in the multi-value mode, which achieves low durability and is advantageous to realize higher capacity, excess security protection can be avoided, and higher capacity can be achieved.

Thus, writing can be performed in accordance with the security level, thereby improving the reliability.

(2) File system can be selected in accordance with a security level, thereby improving convenience.

As shown in FIG. 4, a file system for the system region 31, the secure region 32, and the protect region 33 is an overwrite type file system, which writes data in an order irrelevant to address increment direction (for example, FAT). In this instance, the host apparatus 12 uses the overwrite type file system to control the memory 15 to write data.

Here, the region stores information that is frequently overwritten in small size units, such as key information. Therefore, by using the overwrite type file system to perform writing, decrease of the free areas, which occurs when the incremental-write type file system repeats updating files, can be avoided even if overwriting is frequently performed.

On the other hand, a file system for the general region 34 is an incremental-write type file system, which writes data along the direction in which the address increases one after another, such as UDF. In this instance, the host apparatus 12 uses the incremental-write type file system to control the memory 15 to write data.

Here, the general region 34 holds information that has large size and is used with more information added as required, such as video data. Therefore, by using the incremental-write type file system to perform writing, high speed and efficient writing is possible, thereby improving convenience.

Thus, file system is selected in accordance with the security level, thereby improving convenience.

### Second Embodiment

### One Example of a USB Memory

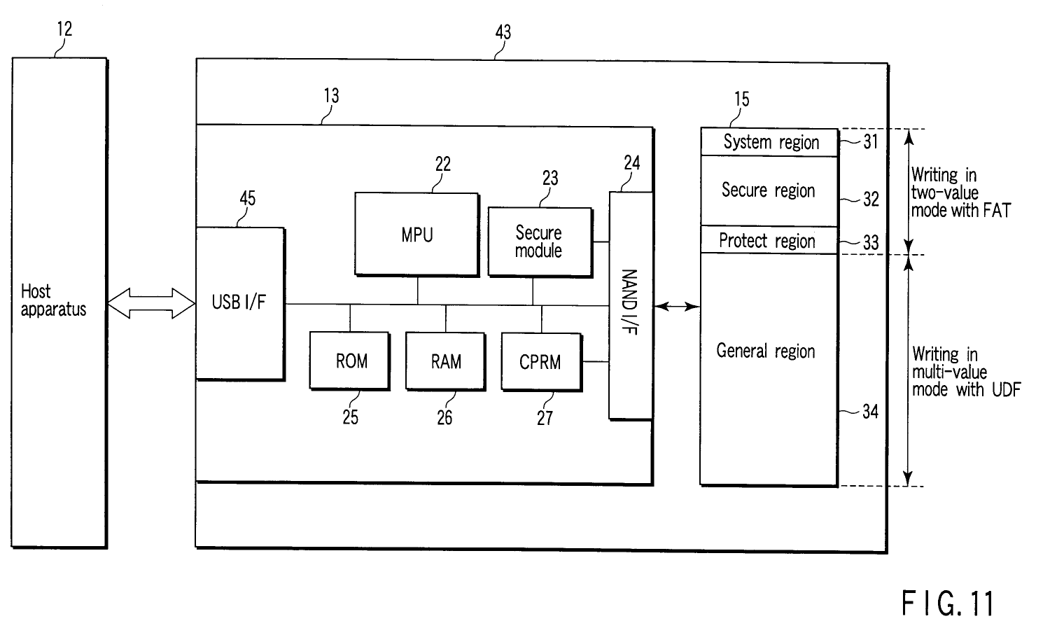

Next, referring to FIG. 11, description will be given of a memory device according to a second embodiment. The embodiment relates to one example of application of a universal serial bus (USB) memory. In the following description, repetitive description on the same elements as those in the first embodiment will be omitted.

As shown, the memory device in the embodiment is different from that of the first embodiment in that the controller 13 includes a USB I/F 45.

The USB memory 43 receives and sends data and the like from and to the host apparatus 12 through the USB I/F 45.

As described above, according to this embodiment, the same advantages as those described above in items (1) and (2) can be obtained. Further, application of the USB memory 43 is possible as shown in the present example when required.

Note that the description is given while using the two-value mode and the multi-value mode taken as examples in the first and second embodiments. However, embodiments are not limited to the instances, and it is possible of writing to a first region, which is one of partitioned memory regions, in an M-value mode and writing to a second region, which provides lower security level than the first region, in an N-value mode (N>M). For example, it is possible of writing to the first region in a four-value mode and writing to the second region in a sixteen-value mode.

Further, the description is given of the first and second embodiments with an instance where a multi-value NAND type flash memory is used as the memory 15 and two-value mode and the multi-mode value are used for writing to the multi-value NAND type flash memory. However, the embodiments are not limited to the instance, and can be applied to the instance of separate two-value NAND type flash memory and multi-value NAND type flash memory as well. Here, the two-value NAND type flash memory means an NAND type flash memory that stores one bit data in one memory cell transistor.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A memory device comprising:
a nonvolatile memory including memory areas that are defined in accordance with a security levels; and
a controller configured to write to a first area that is part of the memory areas in an M-value mode and to a second area that is part of the memory areas and provides lower security level than the first area in an N-value mode (N>M).

2. The device according to claim 1, wherein the first area is managed by an overwrite type file system that writes data in an order that does not depend on addresses.

3. The device according to claim 1, wherein the second area is managed by an incremental-write type file system that sequentially writes data starting from a lower address to a higher address.

4. The device according to claim 3, wherein the incremental-write type file system is DVD-R type file system.

5. The device according to claim 2, wherein:
the first area is a protect region;
the M-value mode is a two-value mode; and
the overwrite type file system is FAT file system.

6. The device according to claim 5, wherein the first area is a system region or a secure region.

7. The device according to claim 3, wherein:
the second area is an general region;
the N-value mode is a multi-value mode; and
the incremental-write type file system is UDF file system.

8. The device according to claim 1, wherein:
the nonvolatile memory is a NAND type flash memory; and
the controller includes a NAND interface.

9. The device according to claim 1, wherein the controller includes at least one of an SD card and a USB interface.

10. The device according to claim 1, wherein the controller comprises:
an SD interface as a host interface;
a micro-processing unit configured to control whole operation of the memory;
a secure module which writes and reads data to and from a secure region in the memory;
a read only memory configured to store firmware for controlling the micro-processing unit;
a random access memory configured to temporarily store a predetermined amount of data and commands; and
a content protection section configured to protect a recordable media module.

11. A controller connectable to a nonvolatile memory that includes memory areas defined in accordance with a security level, controlling the nonvolatile memory, and writing to a first area that is part of the memory areas in an M-value mode and to a second area that is part of the memory areas and provides lower security level than the first area in an N-value mode (N>M).

12. The controller according to claim 11, wherein the first area is managed by an overwrite type file system that writes data in an order that does not depend on addresses.

13. The controller according to claim 11, wherein the second area is managed by an incremental-write type file system that sequentially writes data starting from a lower address to a higher address.

14. The controller according to claim 13, wherein the incremental-write type file system is DVD-R type file system.

15. The controller according to claim 12, wherein:
the first area is a protect region;
the M-value mode is a two-value mode; and
the overwrite type file system is FAT file system.

16. The controller according to claim 15, wherein the first area is a system region or a secure region.

17. The controller according to claim 13, wherein:
the second area is an general area;
the N-value mode is a multi-value mode; and
the incremental-write type file system is UDF file system.

18. The controller according to claim 11, wherein:
the nonvolatile memory is a NAND type flash memory; and
the controller includes a NAND interface.

19. The controller according to claim 11, wherein the controller includes a USB interface.

20. The controller according to claim 11, wherein the controller comprises:
an SD interface as a host interface;
a micro-processing unit configured to control whole operation of the memory;
a secure module which writes and reads data to and from a secure region in the memory;
a read only memory configured to store firmware for controlling the micro-processing unit;
a random access memory configured to temporarily store a predetermined amount of data and commands; and
a content protection section configured to protect a recordable media module.
